(19) United States
(12) Patent Application Publication
(10) Pub. No.: US 2005/0235749 A1
(43) Pub. Date: Oct. 27, 2005

(54) Liquid level monitoring system

(76) Inventor: Jerry Morris, Chickasha, OK (US)

Correspondence Address: DUNLAP, CODDING & ROGERS P.C., PO BOX 16370, OKLAHOMA CITY, OK, 73113, US

(21) Appl. No.: 10/832,935

(22) Filed: Apr. 27, 2004

(51) Int. Cl. G01F 23/00

(52) U.S. Cl. 73/313

(57) ABSTRACT

A liquid level monitoring system for a storage tank is disclosed. The liquid level monitoring system includes a liquid level gauge with a float positionable in the storage tank and weighted to maintain buoyancy on the surface of a liquid contained in the storage tank and a cable having one end connected to the float. The cable is moveable in response to vertical movement of the float caused by changes in the level of the surface of the liquid. A converter assembly is connected to the cable to convert the position of the cable into a position signal indicative of the level of the surface of the liquid in the storage tank. A signal transmitter is operably linked to the converter assembly. The signal transmitter is adapted to receive the position signal and to transmit the position signal. A remote monitoring system is located at a position remote from the storage tank. The remote monitoring system is adapted to receive the position signal indicative of the level of the surface of the liquid in the storage tank from the signal transmitter.

### BACKGROUND OF THE INVENTION

1. Field of the Invention

The present invention relates generally to liquid level gauges, and more particularly, but not by way of limitation, to a liquid level monitoring system.

2. Brief Description of the Related Art

Gauges are commonly utilized in various industries to measure the level of a liquid in a container or tank. With respect to the petroleum industry, gauges are used to measure the level of a liquid in a storage tank. One type of liquid level gauge includes a scale, a float, a level indicator and a second level indicator. a scale is positioned on an exterior surface of a sidewall of a storage tank. The scale has a plurality of markings. A float is positioned in the tank and weighted to maintain buoyancy on the surface of a liquid. A level indicator is connected to the float by a cable and suspended adjacent the scale. The level indicator moves along the scale in response to changes in the level of the surface of the liquid.

While liquid level gauges of this type permit an operator to quickly read the level of the liquid in the storage tank without having to climb onto the storage tank, an operator is nevertheless required to travel to the location of the storage tank. However, storage tanks are generally located near production wells and thus are often located in area that are not always easily accessible. Furthermore, the operator may be responsible for many storage tanks spread over a wide area. As such, it would be beneficial if one had the ability to monitor the level of the liquid in a storage tank from a location remote from the storage tank.

To this end, a need exists for a liquid level monitoring system that is capable of converting the position of a cable connected to a float into a position signal and transmit the position signal to a remote location where it may be readily accessed to permit the level of the liquid in the storage tank to be monitored. It is to such a liquid level monitoring system that the present invention is directed.

### BRIEF DESCRIPTION OF THE SEVERAL VIEWS OF THE DRAWING

FIG. 1 is a partially cut-away, perspective view and partially schematic representation of a liquid monitoring system constructed in accordance with the present invention shown mounted to a storage tank for monitoring the level of a liquid contained with the storage tank.

FIG. 2 is a partially cut-away, perspective view of a liquid level gauge of the present invention.

FIG. 3 is a cross-sectional view of a float.

FIG. 4 is a cross-sectional view of a scale assembly.

FIG. 5 is a partially cut-away, perspective view of another embodiment of a liquid level gauge.

FIG. 6 is a cross-sectional view of another embodiment of a scale assembly.

FIG. 7 is a partially cut-away, perspective view of another embodiment of a liquid level monitoring system constructed in accordance with the present invention shown mounted to the storage tank for monitoring the level of different liquids contained in the storage tank.

### DETAILED DESCRIPTION OF THE INVENTION

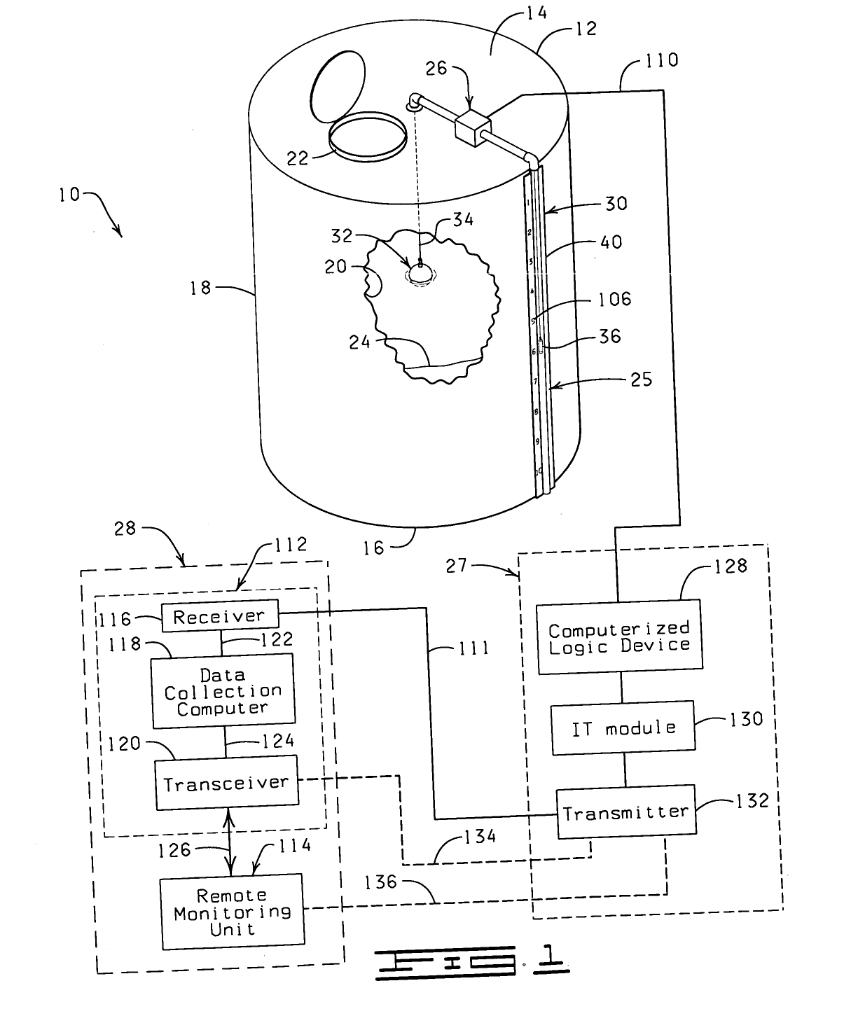

Referring now to the drawings, and more particularly to FIG. 1, a liquid level monitoring system 10 constructed in accordance with the present invention is shown mounted to a storage tank 12. The storage tank 12 is of the type positioned above ground and includes a top wall 14, a bottom wall 16, and a sidewall 18, all cooperating to define an interior space 20. The top wall 14 is provided with a hatch 22 to provide access to the inner space 20. The inner space 20 of the storage tank 12 is shown to contain a liquid 24.

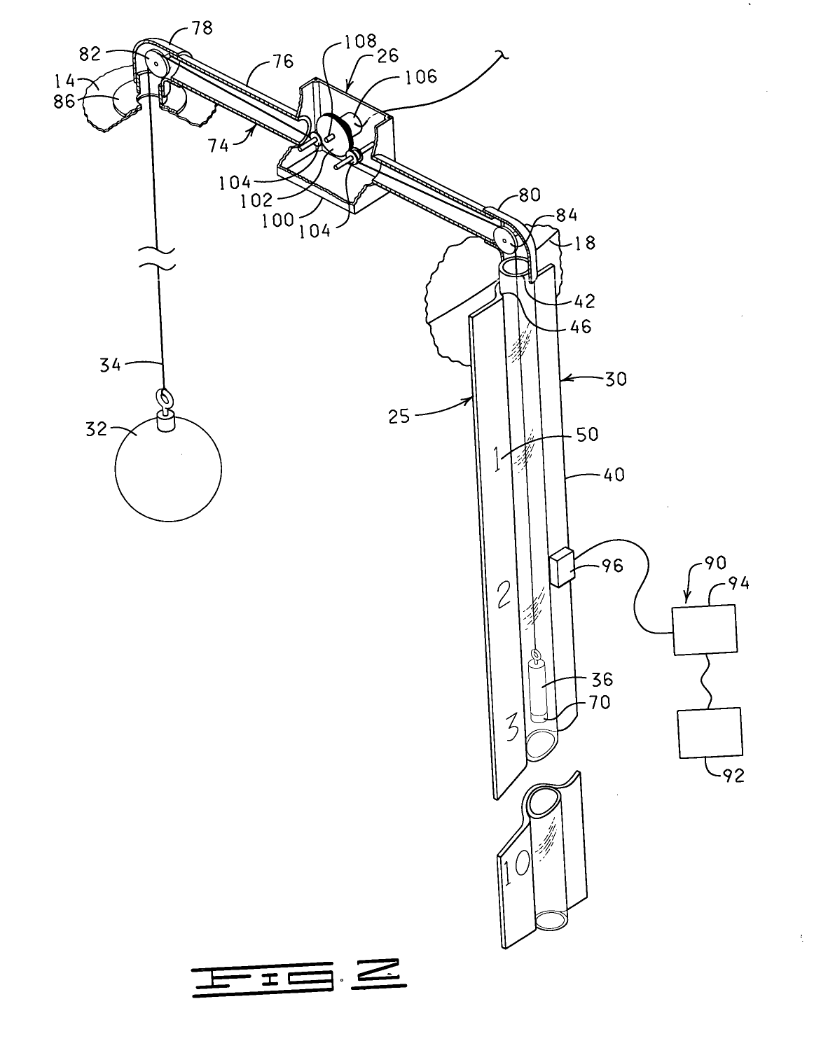

Referring now to FIGS. 1 and 2, the liquid level monitoring system 10 includes a liquid level gauge 25, a converter assembly 26, a signal transmitter 27, and a remote monitoring system 28.

The liquid level gauge 25 includes a scale 30, a float 32, a cable or wire 34, and a level indicator 36. The scale 30 is positioned on the exterior surface of the sidewall 18 on the storage tank 12 to permit an individual to read the level of the liquid 24 while located at ground level on the exterior side of the storage tank 12. The float 32 is positioned in the storage tank 12 and weighted to maintain buoyancy on the surface of the liquid 24. The level indicator 36 is suspended adjacent the scale 30 and connected to the float 32 with the cable 34 so as to be responsive to changes in the level of the surface of the first liquid 24 and thereby provide a visual indicator of the level of the liquid 24 in the storage tank 12.

The converter assembly 26 is connected to the cable 34 to convert the position of the cable 34 into a position signal indicative of the level of the surface of the liquid 24 in the storage tank 12. The signal transmitter 27 is operably linked to the converter assembly 26, and is adapted to receive the position signal and to transmit the position signal. The remote monitoring system 28 is located at a position remote from the storage tank 12 and is adapted to receive the position signal indicative of the level of the surface of the liquid 24 in the storage tank 12 from the signal transmitter 27.

The scale 30 includes a panel member 40 and a level indicator cover 42. The panel member 40 is sized and shaped to be positioned along the exterior side of the sidewall 18 of the storage tank 12 so as to extend from the top wall 14 to the bottom wall 16. As shown, the panel member 40 is substantially rectangularly shaped and provided with a channel 46 for receiving the level indicator cover 42. The channel 46 extends along the length of the panel member 40. The panel member 40 may be constructed of any suitable material, such as plastic, fiberglass, wood, or aluminum.

The level indicator cover 42 is shown to be a transparent tube sized to be positioned in the channel 46. As will be described in greater detail below, the level indicator cover 42 functions to house the level indicator 36 so as to permit the level indicator 36 to travel in an up and down motion in response to changes in the level of the liquid 24 and thereby provide a visual indicator of the level of the liquid 24 without being affected by outside elements, such as wind and rain, which would interfere with the reading of the level of the liquid 24. While the level indicator cover 42 is shown to be tubular, it should be appreciated that the level indicator 42 may be constructed in a variety of configurations so long as the level indicator 36 is visible and capable of traveling freely in an up and down motion along the length of the panel member 40. For example, the level indicator cover 42 could have a semi-circular shape rather than a circular shape. The level indicator cover 42 is secured in the channel 46 of the panel member 40 in a suitable fashion, such as with fasteners or adhesive.

The panel member 40 is provided with a plurality of markings 50 extending from a lower end of the panel member 40 to an upper end of the panel member 40. The markings 50 are used as a reference in measuring the liquid 24 contained in the storage tank 12. As best shown in FIG. 2, the markings 50 are formed as a single column of numbered marks positioned adjacent the level indicator cover 42. The markings 50 may be applied to the panel member 40 in a suitable fashion that permits the markings to be easily seen by an individual. It will be appreciated that the number and spacings of the markings 50 can be varied widely depending on the accuracy of measurement one desires.

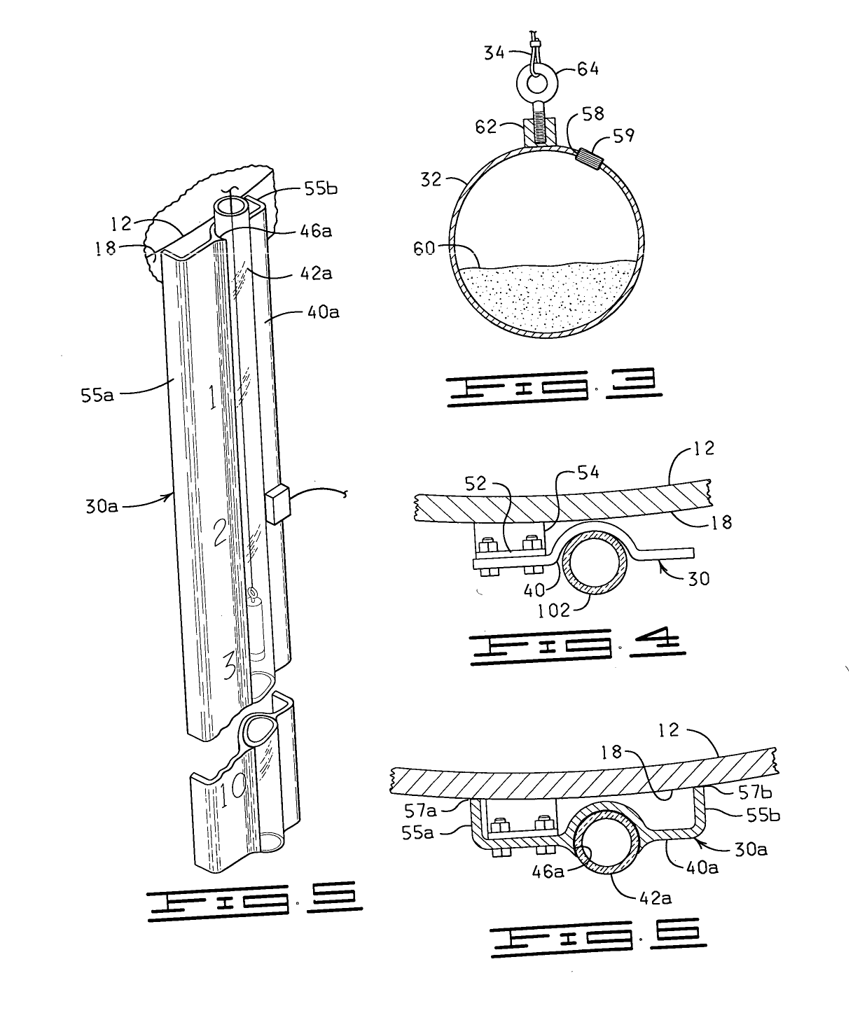

Referring now to FIG. 4, the scale 30 is adapted to be mounted to the exterior side of the sidewall 18 of the storage tank 12 without damaging or effecting the mechanical integrity of the storage tank 12. One way of mounting the scale 30 to the storage tank 12 is to secure a plurality of metal plates 52 (only one plate 52 being shown in FIG. 4) along the rearward side of the panel member 40 and secure a magnet 54 to each of the plates 52. The magnets 54 in turn function to hold the scale 30 against the exterior side of sidewall 18 of the storage tank 12, which is typically constructed of a metal material.

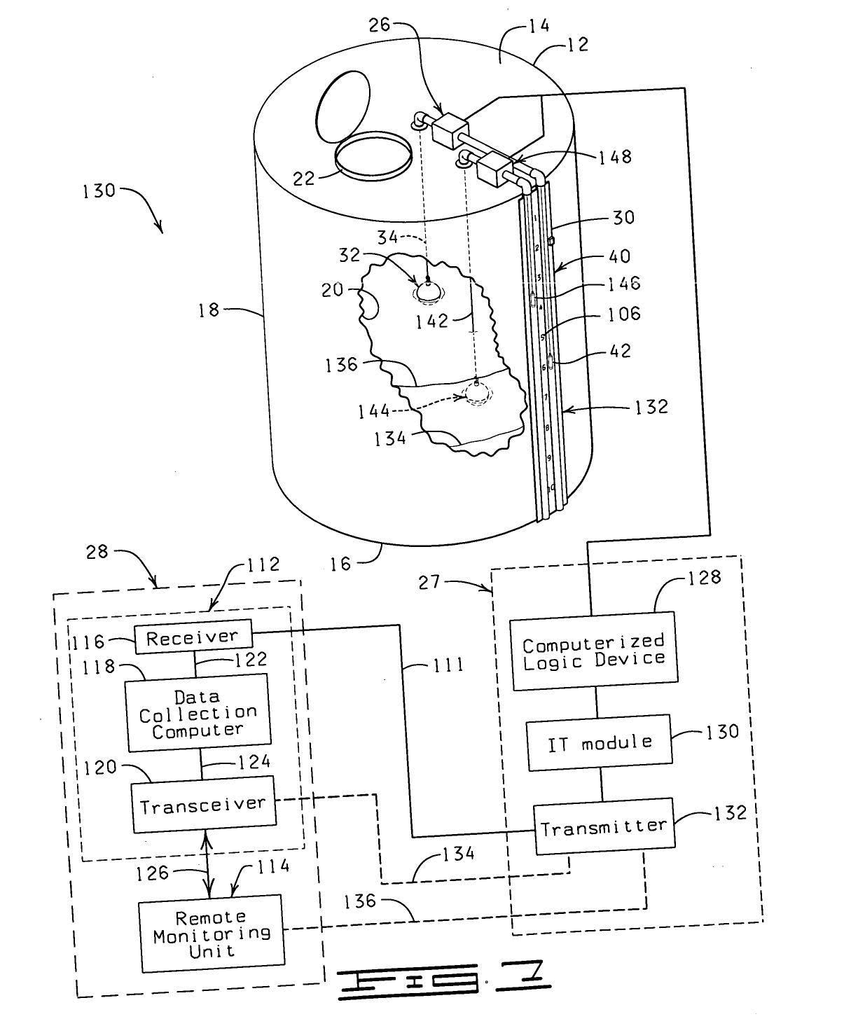

Referring now to FIGS. 5 and 6, another embodiment of a scale 30a is shown. The scale 30a has a panel member 40a and a level indicator cover 42a. The panel member 40a is similar in function to the panel member 40 except the panel member 40a is provided with a pair of wind shields 55a and 55b. The wind shields 55a and 55b are formed on opposite sides of the panel member 40a extending along the length of the panel member 40a. The wind shields 55a and 55b extend rearwardly a distance and define a pair of longitudinal edges 57a and 57b such that the longitudinal edges 57a and 57b engage the exterior side of the sidewall 18 of the storage tank 12 to provide a barrier that reduces the flow of wind between the panel member 40a and the storage tank 12 and thereby prevents the position of the panel member 40a from being altered.

The panel member 40a is further provided with a channel 46a for receiving the level indicator covers 42a. The channel 46a extends along the length of the panel member 40a. The channel 46a is substantially C-shaped and sized to receive the level indicator covers 42a to prevent the level indicator covers 42a from being separated from the panel member 40a.

Referring now to FIG. 3, the float 32 is preferably a hollow sphere constructed of stainless steel. However, it should be understood that any material which permits the float 32 to float on the surface of a liquid may be used to construct the float 32. The float 32 is provided with an opening 58 and a plug 59. The opening 58 permits a ballast material 60 to be disposed within the float 32 to weight the float 32 to maintain buoyancy on the surface of the first liquid 24. When the liquid 24 is water, desirable results have been obtained when the float 32 is provided with an amount of ballast material 60 such as sand, which causes the float 32 to weigh approximately 4 lb. 6 oz. However, when the liquid 24 is a hydrocarbon, desirable results have been obtained when the float 32 is provided with a ballast material which causes the float 32 to weigh approximately 1 lb. to approximately 1 lb. 6 oz. Of course, the ballast required will vary depending on the properties of the liquid in which the float 32 is disposed.

The float 32 is provided with a coupling 62 that is adapted to receive a connector member 64, such as an eye bolt. The connector member 64 of the float 32 is adapted to be connected to one end of the cable 34. The cable 34 serves to connect the float 32 to the level indicator 36.

Referring again to FIG. 2, the level indicator 36 is shown to be a cylindrical member sized to be positioned within the level indicator cover 42. The level indicator 36 is preferably constructed of stainless steel; however, any durable material with sufficient weight to move in response to movement of the float 32 may be used. For reasons to be discussed below, the level indicator 36 may be provided with a magnet 70 on a lower end thereof.

The cable 34 interconnecting the float 32 to the level indicator 36 is supported by a housing 74. The housing 74 has one end mounted to the top wall 14 of the storage tank 12 and another end connected to the level indicator cover 42. The housing 74 includes a tubular extension member 76, a first elbow 78 connected to one end of the tubular extension member 76, and a second elbow 80 connected to the other end. The first elbow 78 is provided with a pulley 82, and the second elbow 80 is provided with a pulley 84. The pulleys 82 and 84 are adapted to rollingly support the cable 34 so that the level indicator 36 moves along the panel member 40 in response to changes in the level of the first liquid 24. The first elbow 78 is connected to the top wall 14 of the storage tank 12 with a slip flange 86, while the second elbow 80 is adapted to mate with the upper end of the level indicator cover 42 thereby forming a continuous enclosure for the cable 34 extending from the top wall 14 of the storage tank 12 to the level indicator cover 42. It will further be appreciated that the housing 74 may be constructed as a single piece, rather than from multiple pieces as described above.

The liquid level gauge 10 is shown to further have a control assembly 90. The control assembly 90 includes a power source 92, a control box 94, and a magnetic switch 96. The control assembly 90 permits automatic control of ancillary devices associated with the storage tank 12, such as pumps and valves, based on predetermined levels of the liquid 24.

The power source 92 may be any source found to be suitable for operating the control assembly 90, such as a DC motor. The control box 94 may be positioned on site or at a remote location from the storage tank 12. The magnet switch 96 is mounted on the panel member 40 of the scale 30 at a predetermined level wherein the magnetic switch 96 is activated in response to the magnet 70 of the level indicator 36 moving to a position adjacent to the magnetic switch 96. Besides the magnetic switch 96, additional magnetic switches may be positioned along the length of panel member 40 to activate specific devices upon the liquid 24 reaching a predetermined level. For example, the control assembly 90 may be utilized to generated high and low alarms, control pumps, and valves.

Referring to FIGS. 1 and 2, the converter assembly 26 is adapted to be mounted on the storage tank 12 adjacent the cable 34. The converter assembly 26 includes a housing 100, a main pulley 102, a pair of idler pulleys 104, and a converter 106. The pulleys 102 and 104 and the converter 106 are enclosed in the housing 100 to protect the pulleys 102 and 104 and the converter 106 from elements, such as rain and wind. The pulleys 102 and 104 and the converter 106 are supported in the housing 100 in any suitable manner, such a bracket (not shown for the sake of clarity) which is in turn connected to the housing 100. The converter assembly 26 is interposed in the tubular extension member 76 of the housing 74. As such, it will appreciated that the converter assembly 60 may be assembled with the liquid level gauge 25 at the time that the liquid level gauge 25 is installed on the storage tank 12 or at a later time as a retrofit. The pulleys 102 and 104 are supported in the housing 100 so as to be rollingly engaged with the cable 34. The main pulley 102 is connected to a shaft 108 which is operably connected to the converter 106.

To accommodate storage tanks of varying capacity, the diameter of the main pulley 102 is varied so as to maintain a consistent ratio between the number of turns of the main pulley 102 from an empty tank position to a full tank position. By way of example, for a storage tank having a height of twenty-four feet, the main pulley 102 may have a diameter of approximately 2.865 inches. However, when the liquid level monitoring system 10 is used with twenty foot storage tank, the diameter of the main pulley 102 may be approximately 2.387 inches. With a sixteen foot storage tank the diameter of the main pulley 102 may be approximately 1.998 inches. It will be appreciated that the diameter of the main pulley 102 may differ from the examples given above depending on the size and type of converter being used.

The converter 106 converts the mechanical movement of the shaft 108 into a corresponding position signal. The position signal produced by the converter 106 can be in analog or digital format. Preferably, the converter 106 is a device known in the art as a shaft encoder, and more preferably, an intrinsic shaft encoder. Suitable shaft encoders are commercially available from Hohner Automation Ltd., Wrexham, Wales, United Kingdom, as part numbers 3AM1-061 R-0342, 3AM1-063R-0342, or 3AM1-0610R-0342. In this embodiment, the position signal output by the converter 106 will be a current signal ranging from about 4 milliamps (empty tank) to about 20 milliamps (full tank). However, it should be understood that the converter 106 can be any type of device capable of converting mechanical movement of the shaft 108 into the position signal indicative of the position of the shaft 108 and thus indicative of the level of the surface of the liquid 24 in the storage tank 12. In one embodiment, the converter 106 will convert the movement of the shaft 108 into an electrical signal. However, it should be understood that the converter 106 can convert the movement, and/or rotational position of the shaft 108 into any type of signal capable of identifying the rotational position and/or movement of the shaft 108, such as an optical signal. It should also be understood that the converter 106 can be implemented in various manners. For example, the converter 106 can be implemented as a potentiometer.

Returning to FIG. 1, the converter assembly 26 outputs the position signal to the signal transmitter 27 via a communication link 110. The signal transmitter 27 is shown mounted near the storage tank 12, preferably outside of a hazardous area usually defined by a firewall (not shown) formed about the storage tank 12. However, it should be understood that the signal transmitter 27 may be mounted on the storage tank 12. In either case, a suitable protective device, such as a zenner safety barrier, may be installed to prevent an explosion.

The term “communication link”, as used herein, refers to any suitable communication medium which permits electronic or optical communications, such as extra computer communication systems, intra computer communication systems, internal buses, local-area networks, wide area networks, point-to-point shared and dedicated communications, infrared links, microwave links, telephone links, cable TV links, satellite links, radio links, fiber-optic links, cable links and/or combinations thereof. It should be understood that each of the communication links are shown and described separately herein for the sole purpose of clearly illustrating the information being communicated between the various components. The communication links may not be separate communication links and may be a single communication link.

The signal transmitter 27 receives the position signal from the converter assembly 26 via a communication link 111. In response thereto, the signal transmitter 27 conditions the position signal into a format understandable or readable by the remote monitoring system 28. The remote monitoring system 28 is preferably provided with a data collection system 112 and a remote monitoring unit 114. The data collection system 112 includes a receiver 116, a data collection computer 118, and a transceiver 120. The receiver 116 and the transceiver 120 communicate with the data collection computer 118 via communication links 122 and 124, respectively. The transceiver 120 communicates with the remote monitoring unit 114 via a communication link 126.

In use, the signal transmitter 27 receives the position signal from the converter assembly 26 in either a digital or analog format. The position signal is then conditioned or transformed into the format understandable by the receiver 116 of the data collection system 112. The signal transmitter 27 transmits the position signal to the receiver 116. The receiver 116 receives the position signal and communicates such position signal to the data collection computer 118 where such position signal is then stored. Once the position signal is stored by the data collection computer 118, such position signal is then available to be read by the remote monitoring unit 114. The remote monitoring unit 114 preferably communicates bi-directionally with the transceiver 120. To retrieve the position signal, the remote monitoring unit 114 outputs a signal to the transceiver 120 via the communication link 126 and such retrieval signal is received by the transceiver 120. The transceiver 120 communicates with the data collection computer 118 via the communication link 124 so as to retrieve the position signal and subsequently output such position signal to the remote monitoring unit 114 via the communication link 126.

The remote monitoring unit 114 can be any type of computerized device capable of receiving the position signal and outputting the position signal in either computer and/or human readable format. In one preferred embodiment, the remote monitoring unit 114 can be a web-enabled device, such as a personal computer, mainframe computer, cellular telephone, personal data assistant, or the like.

The signal transmitter 27 and the receiver 116 can be any commercially available device capable of transmitting and receiving the position signal as discussed herein. In one embodiment, the communication link 111 between the signal transmitter 27 and the receiver 116 is an Ethernet radio link. The data collection computer 118 is any type of device capable of receiving, storing, and retrieving the position signal as discussed herein. Typically, the data collection computer 118 will be an IBM-compatible personal computer programmed with a database or spreadsheet program.

In certain embodiments, it will be desirable to log the level of the liquid within the storage tank over time. In this instance, at least one of the converter assembly 26, the signal transmitter 27, the receiver 116, or the data collection computer 118 will include a clock, or will receive a clock signal so as to incorporate a time component into the position signal. For example, in one embodiment the signal transmitter 27 receives a clock signal and incorporates the time component into the position signal transmitted to the receiver 116.

In one embodiment, the signal transmitter 27 may include a computerized logic device 128. The computerized logic device 128 may be a programmable logic controller, central processing unit, digital signal processor, microcontroller, and/or an input analog module which converts the analog current signal output by the converter 106 into a digital signal. The computerized logic device 128 may also be programmed to convert the position signal into desired units of measure, such as feet of liquid and/or barrels of liquid.

The signal transmitter 27 may also include an Internet terminal module 130 for displaying the position signals via a web page. In such case, the position signals are transmitted from the Internet terminal module 130 directly to the transceiver 120 by a transmitter 132 via a communication link 134 where the position signals may be accessed by the remote monitoring unit 114. Alternatively, the position signals may be accessed at the Internet terminal module 130 directly via the remote monitoring unit 114 via a communication link 136.

The signal transmitter 27 can also be provided with a storage unit, such as a memory, CD-ROM, hard disk, floppy disk, optical storage unit, or the like, for logging the position signals and storing the position signals. Thus, the position signals can be output to the receiver 116 in real-time, or the position signals can be stored at the signal transmitter 27 and downloaded periodically by the data collection system 112. Alternatively, the remote monitoring unit 114 can download or otherwise receive the position signals directly from the signal transmitter 27.

It should be understood that the data collection system 112 may be utilized to receive position signals from more than one signal transmitter. In this embodiment, each signal transmitter 27 is associated with a unique or particular storage tank, and a tank identification code is included in the position signal transmitted to the receiver 116 of the data collection system 112. Thus, the data collection system 112 can receive, store, and/or provide data indicative of the liquid levels for more than one storage tank.

Referring now to FIG. 8, another embodiment of a liquid level monitoring system 130 is shown. The liquid level monitoring system 130 is similar in construction and function to the liquid level monitoring 10 except that it includes a liquid level gauge 132 that is constructed to measure the levels of two distinct liquids. In the petroleum industry, gauges are used to measure the level of a liquid in a storage tank. However, in the production of hydrocarbons, water and hydrocarbon liquids are often found in the same tank. Because water has a greater specific gravity than the hydrocarbon liquids, the water and the hydrocarbon liquids separate with the water settling to the bottom of the tank and the hydrocarbon liquids laying on top of the water.

FIG. 8 shows two liquids, a first liquid 134 and a second liquid 136 disposed in the storage tank 12. The first liquid 134 has a specific gravity that is greater than the specific gravity of the second liquid 136. As such, the first liquid 134 settles toward the bottom wall 16 of the storage tank while the second liquid 136 floats on top of the first liquid 134. It will be appreciated that the first liquid 134 may be water while the second liquid 136 may be a hydrocarbon liquid which is insoluble in water and thereby results in a distinct line of demarcation between the water and hydrocarbon liquid which permits the level of the first liquid 134 and level of the second liquid 136 to be measured separately.

The liquid level gauge 132 is similar in construction to the liquid level gauge 25 described above with the exception that the liquid level gauge 132 further includes a second cable 142, a second float 144, a second level indicator 146, and a second converter assembly 148. The second float 144 is constructed in a manner similar so the first float 32. However, desirable results have been obtained when the second float 144 is provided with a ballast material which causes the second float 144 to weigh approximately 1 lb. to approximately 1 lb. 6 oz. Of course, the ballast required will vary depending on the properties of the liquid in which the first and second floats 32 and 144 are disposed. The second float 144 is installed so that the second float 144 is laterally spaced relative to the first float 32 to prevent interference with the operation of the first float 32 and the second float 144. With respect to calibration of the second level indicator 146, this is accomplished by measuring the level of the second liquid 136 with methods that are well known in the art. The second converter assembly 148 is operably linked to the signal transmitter 27. The second cable 142, the second float 144, the second level indicator 146, and the second converter assembly 148 function the same as the cable 30, the float 32, the level indicator 42, and the converter assembly 26, respectively, except as has been hereinbefore described.

From the above description, it is clear that the present invention is well adapted to carry out the objects into obtaining advantages mentioned herein as well as those inherent in the invention. While a presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

1. A liquid level monitoring system for a tank, comprising:
a float positionable in the tank and weighted to maintain buoyancy on the surface of a liquid contained in the tank; and
a cable having one end connected to the float, the cable moveable in response to vertical movement of the float caused by changes in the level of the surface of the liquid;
a converter assembly connected to the cable to convert the position of the cable into a position signal indicative of the level of the surface of the liquid in the tank;
a signal transmitter operably linked to the converter assembly, the signal transmitter adapted to receive the position signal and to transmit the position signal; and
a remote monitoring system located at a position remote from the tank, the remote monitoring system adapted to receive the position signal indicative of the level of the surface of the liquid in the tank from the signal transmitter.

2. The liquid level monitoring system of claim 1 wherein the remote monitoring system comprises:
a receiver adapted to receive the position signal from the signal transmitter;
a data collection computer operably linked to the receiver, the data collection computer adapted to store the position signal; and
a remote monitoring unit operably linked to the data collection computer to permit the stored position signal to be monitored from a remote location.

3. The liquid level monitoring system of claim 1 wherein the converter assembly further comprises:
a pulley rollingly engaged with the cable; and
an encoder connected to the pulley such that the rotational position of the pulley is converted into the position signal indicative of the level of the surface of the liquid in the tank.

4. The liquid level monitoring system of claim 1 wherein the encoder is intrinsically housed and wherein the converter assembly is mountable to the tank.

5. The liquid level monitoring system of claim 1 further comprising:
a scale positionable on an exterior surface of the tank, the scale having a plurality of markings extending from a lower end of the scale to an upper end of the scale; and
a counterweight connected to the cable and suspended adjacent the scale to provide a visual indicator of the level of the liquid in the tank.

6. The liquid level monitoring system of claim 1 further comprising:
a second float positionable in the tank and weighted to maintain buoyancy on the surface of a second liquid contained in the tank; and
a second cable having one end connected to the second float, the second cable moveable in response to vertical movement of the second float caused by changes in the level of the surface of the second liquid;
a second converter assembly connected to the second cable to convert the position of the second cable into a second position signal indicative of the level of the surface of the second liquid in the tank.

7. The liquid level monitoring system of claim 6 wherein the remote monitoring system is adapted to receive the second position signal indicative of the level of the surface of the second liquid in the tank from the signal transmitter.

8. A liquid level monitoring system in combination with a storage tank containing a liquid, the storage tank having a sidewall with an exterior surface, the liquid level monitoring system comprising:
a float positioned in the storage tank and weighted to maintain buoyancy on the surface of the liquid contained in the storage tank;
a cable having one end connected to the float, the cable moveable in response to vertical movement of the float caused by changes in the level of the surface of the liquid;
a converter assembly connected to the cable to convert the position of the cable into a position signal indicative of the level of the surface of the liquid in the storage tank;
a signal transmitter operably linked to the converter assembly, the signal transmitter adapted to receive the position signal and to transmit the position signal; and
a remote monitoring system located at a position remote from the storage tank, the remote monitoring system adapted to receive the position signal indicative of the level of the surface of the liquid in the storage tank from the signal transmitter.

9. The combination of claim 8 wherein the remote monitoring system comprises:
a receiver adapted to receive the position signal from the signal transmitter;
a data collection computer operably linked to the receiver, the data collection computer adapted to store the position signal; and
a remote monitoring unit operably linked to the data collection computer to permit the stored position signal to be monitored from a remote location.

10. The combination of claim 8 wherein the converter assembly further comprises:
a pulley rollingly engaged with the cable; and
an encoder connected to the pulley such that the rotational position of the pulley is converted into the position signal indicative of the level of the surface of the liquid in the storage tank.

11. The combination of claim 8 wherein the encoder is intrinsically housed and wherein the converter assembly is mountable to the storage tank.

12. The combination of claim 8 further comprising:
a scale positioned on an exterior surface of the storage tank, the scale having a plurality of markings extending from a lower end of the scale to an upper end of the scale; and
a level indicator connected to the cable and suspended adjacent the scale to provide a visual indicator of the level of the liquid in the tank.

13. The combination of claim 8 further comprising:
a second float positionable in the storage tank and weighted to maintain buoyancy on the surface of a second liquid contained in the storage tank; and
a second cable having one end connected to the second float, the second cable moveable in response to vertical movement of the second float caused by changes in the level of the surface of the second liquid;
a second converter assembly connected to the second cable to convert the position of the second cable into a second position signal indicative of the level of the surface of the second liquid in the storage tank.

14. The combination of claim 13 wherein the remote monitoring system is adapted to receive the second position signal indicative of the level of the surface of the second liquid in the storage tank from the signal transmitter.

15. A method of monitoring a liquid level in a tank, comprising:
positioning a float in the tank, the float being weighted to maintain buoyancy on the surface of a liquid contained in the tank;
connecting one end of a cable to the float such that the cable is moveable in response to vertical movement of the float caused by changes in the level of the surface of the liquid;
converting the position of the cable into a position signal indicative of the level of the surface of the liquid in the tank;
transmitting the position signal to a remote location; and
receiving the position signal at the remote location; and
monitoring the position signal at the remote location.
